(19) United States
(12) Patent Application Publication
(10) Pub. No.: US 2010/0153266 A1
(43) Pub. Date: Jun. 17, 2010

(54) SYSTEM FOR AND METHOD OF COLLECTION OF GOVERNMENT AND EDUCATIONAL PAYMENTS, INCLUDING A CONVENIENCE FEE, USING PAYMENT CARDS

(76) Inventors: James B. PLUNKETT, Auburn, ME (US); Philip A. Telesco, San Francisco, CA (US); Lucille Plunkett, Rockport, MA (US)

Correspondence Address: Vedder Price, PC, 875 15th Street, NW, Suite 725, Washington, DC, 20005, US

(21) Appl. No.: 12/398,561

(22) Filed: Mar. 5, 2009

Related U.S. Application Data
(60) Provisional application No. 61/122,818, filed on Dec. 16, 2008.

(51) Int. Cl. G06Q 20/00

(52) U.S. Cl. 705/40

(57) ABSTRACT

A system includes an authorization device and one or more payment servers for entering payment and payment card information and determining any issuing fees and any convenience fee for transactions paid using the two or more types of payment cards. The one or more payment servers are in electronic communication with a payment card financial network for authorizing and settling transactions entered by two or more types of payment cards. Each transaction may comprise one or more government and/or educational payments. The payment servers automatically determine the one or more convenience fees for each transaction. The authorization device allows the user to authorize the payment of the government or educational fees, any secondary fees and any convenience fees simultaneously with a single swipe or key entry of the payment card information, thereby automatically complying with payment card convenience fee requirements.

### PRIORITY DATA AND INCORPORATION BY REFERENCE

This application claims benefit of priority to U.S. Provisional Patent Application No. 61/122,818, entitled “System for and method of rapid collection of taxes and fees using payment cards which are directly settled into appropriate deposit (merchant) accounts,” filed Dec. 16, 2008 which is incorporated herein by reference in its entirety.

### BACKGROUND OF THE INVENTION

1. Field of the Invention

The present invention relates to a method and system for collection of government and/or educational payments, including a convenience fee, with a payment card as part of a payment transaction.

2. Background of the Technology

MasterCard™ after going public in 2007 looked closely at their Public Sector business. MasterCard™ was capturing less than $2 billion in annual credit card transactions from governments and educational entities and estimated that potential market at over $300 billion in potential credit and debit card transactions annually. After 14 years of prohibiting governments and educational entities to assess a fee back to their citizens and students that wanted to pay with a credit or debit card, MasterCard™ changed its policies to allow a “convenience fee” to be assessed back on all channels of payment including: in-person, over the phone, in the mail and online. Also, MasterCard™ changed its policies to allow a “convenience fee” to be assessed in all government departments and operations as well as for tuition and on-site room and board in educational entities.

These changes in policies were significant, because it is estimated that more than 95% of local governments and more than 75% of all educational institutions are not accepting credit cards in their offices, because they cannot budget the transaction costs assessed by the credit card companies. Four months after MasterCard changed its convenience fee policy, American Express similarly changed their policy. Six months after that, in October 2008, Visa™ also changed their rules, but only for property and business tax payments.

MasterCard™ strongly recommends, as what they term “Best Practice” in their new convenience fee policy, that any “convenience fee” be conducted as a separate transaction from the government payments being collected. Visa™'s new Tax Payment Program effective October, 2008 requires the “convenience fee” be submitted and processed as a separate transaction. Visa™'s Tax Program applies to Federal and state personal income taxes, property taxes and Federal and state business income taxes. This requirement presented numerous issues with governments wishing to accept credit and debit cards for payment, the most obvious being the issues associated with swiping or key entering a citizen's card twice. Visa™'s new Tax Payment Program also introduced a new “differentiated interchange” (the wholesale transaction cost assessed to payment processors) of $2.50 for Visa™ debit payments for income, property and business taxes to incent the use of debit cards for income, property and business tax payments. Visa™ requires that the convenience/service fee assessed to the citizen by any governmental tax collecting entity or any third party on its behalf, on Visa™ debit payments to not exceed $3.95. Where convenience fees were permitted in the past by MasterCard™ & Visa™ as either a flat fee or a variable (percentage) fee, Visa™'s new Tax Payment Program represents the first time a “differentiated convenience fee” based on something other than the transaction amount has been introduced by any of the credit card companies.

Visa™ and MasterCard™ both have historically introduced differentiated interchange rates to provide incentive for increased usage of different payment card types (e.g. debit cards) in different sectors which Visa™, MasterCard™, American Express™ and Discover call merchant category codes (e.g tax collection, courts, utilities, education etc.), for different payment types (e.g. small ticket & large ticket, taxes) and in different payment channels (e.g. face to face card present). Visa™ and MasterCard™'s differentiated interchange has been traditionally borne by the merchant accepting the credit cards (because surcharges, convenience fees and service fees were not allowed). In the public sector the differentiated interchange was easily handled by local governments, educational entities and third parties enabling local governments and educational entities to offer online payments, by combining the convenience fee and the local government payment as one transaction. Now, with the introduction of new rules requiring the tax payments and the convenience fee to be processed as two separate transactions and the introduction of a differentiated convenience fee for Visa™ debit tax payments, to encourage use of the Visa™ debit product for property tax and income tax payments and with the convenience fee being borne by the payer, existing solutions do not offer an acceptable method to enable governments to easily accept payment cards with a differentiated convenience fee.

### SUMMARY OF THE INVENTION

According to one broad aspect, the present invention provides a system comprising: an authorization device; and one or more payment servers for entering payment and payment card information and determining any secondary fees and one or more differentiated convenience fees for transactions paid using the two or more types of payment cards, wherein the one or more payment servers are in electronic communication with a payment card financial network for authorizing and settling transactions entered by two or more types of payment cards, wherein each transaction comprises one or more government and/or one or more educational payments, wherein the one or more payment servers automatically determine the one or more differentiated convenience fee for each transaction based on: the transaction amount and/or the payment card characteristics and/or the payment type and/or the payment channel, wherein an authorization device in electronic communication with the payment server allows the user to authorize the payment of the one or more government payments and/or the one and/or more educational payments and the payment of the one or more convenience fees simultaneously with a single swipe or key entry of the payment card information, thereby automatically complying with one or more payment card differentiated convenience fee requirements.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 is a diagram of the authorization of the separate transactions with a single swipe or key entry of a credit or debit card and the settlement to separate deposit according to one embodiment of the present invention;

FIG. 2 is a diagram showing the three embodiments of the system of the present invention: (1) an ecommerce system in an unsecured or secured environment, (2) an in-office payments system employing a virtual terminal with a secure login and (3) a business management or IVR system integrated system using an application programming interface (API) with a secured connection;

FIG. 3 is drawing of the transaction receipt according to one embodiment of the present invention; and

FIG. 4 is a diagram of a transaction process including voids and declines according to one embodiment of the present invention.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

For the purposes of the present invention, directional terms such as “top”, “bottom”, “upper”, “lower”, “above”, “below”, “left”, “right”, “horizontal”, “vertical”, “upward”, “downward”, etc. are merely used for convenience in describing the various embodiments of the present invention.

For the purposes of the present invention, a value or property is “based” on a particular value, property, the satisfaction of a condition, or other factor, if that value is derived by performing a mathematical calculation or logical decision using that value, property or other factor.

For the purposes of the present invention, the term “authorization device” refers to any type or combination of the following such devices: a magnetic card reader, a touch screen, a user's computer, an electronic signature pad, a keypad, a video display etc. that may be used by a user to authorize a payment. The authorization device may be the same or different as the data entry device the user uses to enter the payment card information.

For the purposes of the present invention, the term “automatically determine” refers to a determination made by a payment server.

For the purposes of the present invention, the term “convenience fee” refers to fees that are applied because the payment channel provides a bona fide convenience for payment outside of the merchants customary payment channels (e.g. interactive voice response (IVR) systems, internet and kiosks), service fees such as those allowed in Visa™'s Tax Payment Program and surcharges or other “fees” that are added onto the transaction primarily to offset the government and/or educational entities costs that are assessed on that transaction. A convenience fee may be based on one or a combination of several factors. These factors may include: the payment amount, the payment card characteristics, the payment type characteristics and the payment channel characteristics.

For the purposes of the present invention, the term “data entry device” refers to any device or combination of devices that may be used by a user to enter payment card and or transaction amount information. Examples of data entry devices include computer keyboards, terminals, touch screens, magnetic card readers, smart card readers, RFID (radio frequency identification) tag readers, electronic tablets, cell phones, MP three players, etc.

For the purposes of the present invention, the term “differentiated convenience fee” refers to a convenience fee that involves “differentiated interchange” i.e. the wholesale transaction cost is assessed to one or more payment processors.

For the purposes of the present invention, the term “educational payment” refers to a payment to an entity providing educational services.

For the purposes of the present invention, the term “government payment” refers to a payment to a government entity.

For the purposes of the present invention, the term “payment amount dependent convenience fee” is a convenience fee that is based on the amount paid by a user for one or more payments that are part of a particular transaction. A variable convenience fee may be calculated as a percentage of the amount paid by a user in a transaction. Alternatively, the amount of a variable convenience fee may be a fixed fee based on a transaction falling within a particular range or a series of ranges. For example: a convenience fee of $2 may be charged for transactions between 0 and $100, a convenience fee of $4 may be charged for transactions greater than $100 but less than $250, etc. There may also be minimum and/or maximum caps on a variable convenience fee. For example, the convenience fee may be capped at $99, or there may be a $1.50 minimum convenience fee regardless of the size of the transaction even though the convenience fee is a percentage of the amount paid.

For the purposes of the present invention, the term “payment card differentiated convenience fee requirements” refers to the requirements that must be complied with to allow a user to use a credit to pay a differentiated convenience fee. Examples of payment card differentiated convenience fee requirements include: Visa™'s Tax Payment Program requirements and MasterCard's “Best Practice” section of their convenience fee program rules.

For the purposes of the present invention, the term “payment card financial network” refers to a linked telecommunications network of payment card issuers, acquirers and data processing centers. Examples of payment card financial networks are Banknet™ operated by MasterCard™ and VisaNet™ operated by Visa™.

For the purposes of the present invention, the term “payment card” refers to any type of card used to make monetary payments. Examples of payment cards include: credit cards, debit cards, smart cards, etc.

For the purposes of the present invention, the term “payment card characteristic” refers to any characteristic associated with a particular payment card. Examples of payment card characteristics include: they type of payment card, such as a credit card, a debit card, a smart card, etc.; the card company, such as Visa™, Mastercard™, American Express™; the marketing characteristics of the card such as a rewards or affinity card, the bank or other institution issuing the card and/or the particular user account associated with the card (e.g. consumer, business, commercial etc.).

For the purposes of the present invention, the term “payment card type dependent convenience fee” is a convenience fee that is based on the type of payment card that is being used to pay for a transaction. For example, the amount of the convenience fee may be based on whether the card is a credit card, debit card or other type of payment card such as a smart or mini card.

For the purposes of the present invention, the term “payment card brand dependent convenience fee” is a convenience fee for a transaction that is based on the brand of the payment card, used to pay for the transaction is associated. For example, MasterCard™, Visa™, Discover™ and JCB™ etc., may affect the amount of the convenience fee.

For the purposes of the present invention, the term “payment channel” means the physical method in which the payment card is presented and processed. Examples of payment channels include: face to face card present magnetic card reader, face to face card present smart card, over the phone card not present, in the mail card not present, online card not present, mobile phone card not present etc.

For the purposes of the present invention, the term “payment channel dependent convenience fee” is a convenience fee that is based on where and how the payment is made. For example, the amount of a convenience fee may be different depending on whether the payment is made using a payment card in-person, at a kiosk, over the phone, in the mail, on-line, etc.

For the purposes of the present invention, the term “payment gateway” refers to an e-commerce application service provider service that authorizes payments for commerce transactions.

For the purposes of the present invention, the term “payment type dependent convenience fee” is a convenience fee that is based on the type merchant category code (e.g. taxes, courts or education) and or the type of transaction that a payment card is being used to pay. For example, a convenience fee may be based on whether a payment card is being used to pay for a particular type of service or goods (e.g. income taxes, tuition); whether the government fee or tax is a local, state or federal government tax; the particular government or educational entity being paid, etc. The payment type may also be a function of the transaction size (e.g. small ticket and large ticket amounts whereby a convenience fee is determined if the transaction size is below or above said amounts).

For the purposes of the present invention, the term “secured connection” refers to a network connection that is protected by a cryptographic protocol that provides security and data integrity. Examples of cryptographic protocols include Transport Layer Security (TLS) and Secure Sockets Layer (SSL).

For the purposes of the present invention, the term “third party” refers to any company that holds, transmits, stores or has access to payment card data for another party, in this case a government or educational entity and that collects revenues on the government or educational entities behalf.

For the purposes of the present invention, the term “transaction” refers to one or more payments and a convenience fee or other fees that are authorized simultaneously by a user.

For the purposes of the present invention, the term “visual display device” or “visual display apparatus” includes any type of visual display device or apparatus such as a CRT monitor, LCD screen, LEDs, a projected display, a printer for printing out an image such as a picture and/or text, etc. A visual display device may be a part of another device such as a computer monitor, television, projector, telephone, laptop computer, watch, microwave oven, electronic organ, automatic teller machine (ATM) etc.

### Description

The present invention relates generally to aggregation of separate government or educational fees, taxes, fines, tuition and other payments including a convenience fee that is automatically calculated and assessed to the payer and authorization of all of the separate fees simultaneously with a single swipe or key entry of a credit or debit card, including settlement of the separate transactions into one or more deposit (taxing, fee authority or third party) accounts.

The present invention not only automatically facilitates submitting and processing two or more separate transactions, one or more for the government or educational entities payments and one for the convenience fee (in compliance with Visa™'s Tax Payment Program) it automatically manages a differentiated convenience fee (also required as part of Visa™'s Tax payment Program) and it allows the convenience fee and the total amount of the transaction to be optionally presented to the user before authorization, and automatically and simultaneously settles the government or educational entities fees and the convenience fee and settles the fees to a single or separate merchant account(s) which may be held by the government or educational entity collecting the fees or by an authorized third party on their behalf thereby removing the government or educational entity from all aspects of the fee collection so that they can accept payment cards at no cost.

In one embodiment the present invention provides a system and a method for collection and aggregation of government and/or educational payments including: taxes, fees, fines, tuition and other payments with credit and debit cards on a frequent, regular basis, such as real-time or on a regular time interval (recurring payments) that may be used for face-to-face, telephone, mail order, e-commerce or other transactions. In one embodiment the present invention provides a system and a method for aggregating the primary fees and payments, any secondary (e.g. issuing) fees and any “convenience fee” collectively “fees automatically calculated by the system, and authorization of the fees, simultaneously, as multiple and separate transactions, with one swipe of the magnetic strip of a payment card or key entry of the payment card data. In one embodiment the present invention also provides a system and a method for settlement of the separate transactions to a single or to multiple deposit account(s) including potentially a convenience fee account held by either the collecting entity or a third party on their behalf and perhaps several taxing or fee collecting authorities with each taxing or fee collecting authority seeking to receive funds from many “agents” authorized to collect their taxes, fees, fines, tuition or other payments. One embodiment of the present invention includes a standalone virtual terminal accessed via the internet through a secure connection. Another embodiment of the present invention involves an application program interface/payment gateway which allows the embodiment of the present invention to be integrated or appended to existing business management software, web pages and websites, interactive voice response (IVR) systems, bill presentment systems and kiosks etc.

The primary attribute of the inventive concept is that it allows a separate convenience fee which may now be assessed back to the payer, in different payment channels, under new credit card company rules, to be automatically calculated as a percentage, fixed or flat amount as a function of the total transaction amount and also as a function of the payment card characteristics, the payment type and/or the payment channel or any combination of any or all of the preceding factors, and authorized and settled as a separate transaction from the primary fees being collected with a single swipe or key entry of a credit or debit card. The inventive concept allows separate convenience fees to be applied to separate payment types within the same transaction and for those payment types to be settled to the same or separate merchant accounts (separate merchant ID's). The convenience fee may be collected by the taxing or fee collecting authority or by an authorized third party, eliminating the taxing or fee collecting authority from any involvement in the fee collection.

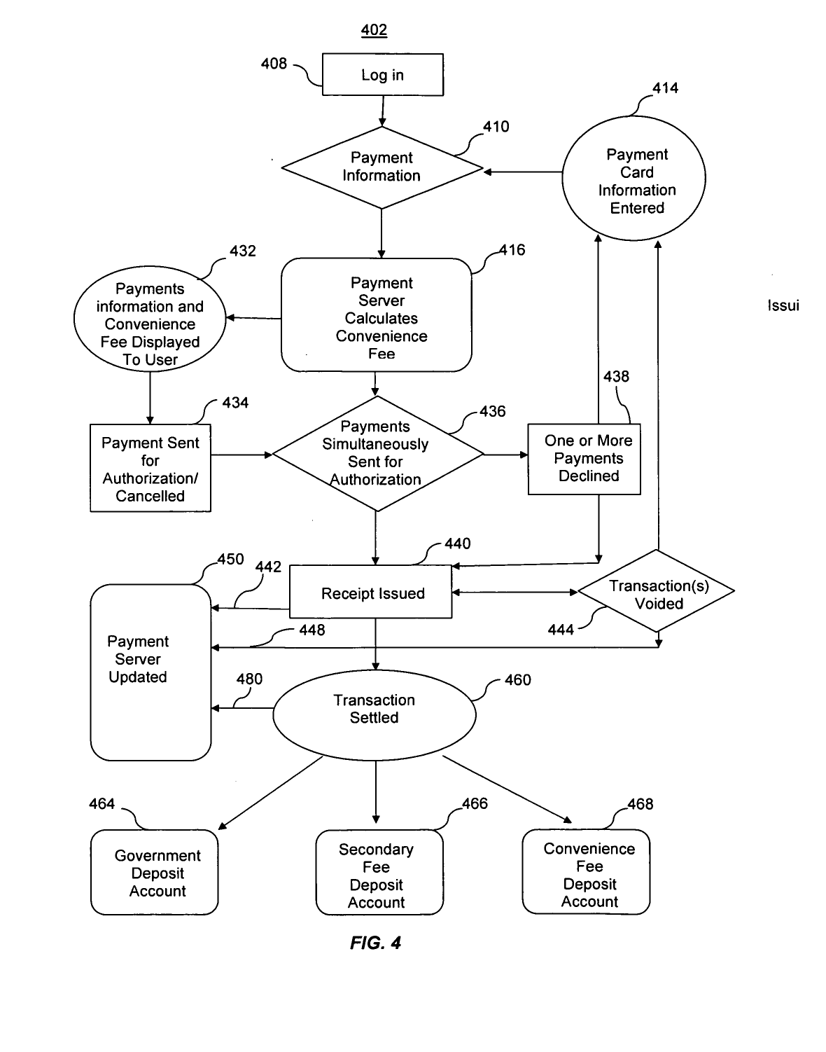

In one embodiment of the invention, the system may be accessed as virtual terminal via the internet or through an existing business management software solution after being integrated using an application program interface (API) which may include Direct Socket Integration, XML Web Service, COM Object or HTTP POST or other similar methodology. In this embodiment a user enters the payment information and the payment card information on the authorization device which connects to the payment servers with a secure connection and a first signal is sent from the authorization device with the payment and the payment card information is sent from the authorization device to the payment server and causes the payment server to access a payment server database pursuant to the determining the amount of the convenience fee. The payment server then optionally sends a signal back to the video display of the authorization device presenting the convenience fee, the individual government payments including any secondary (issuing) fee and the total transaction amount to the user with the option to authorize or cancel the transaction. A second signal is sent by the by the payment server, to authorize the transaction and generate a printed receipt, such as shown in FIG. 4, described in greater detail below, with separate transaction details and signature line for each transaction amount. In this embodiment the authorization device may also include an electronic signature capture device where one electronic signature authorizes both transactions. Alternatively, the second step where the transaction information is presented on the video display before authorization is bypassed and the convenience fee is automatically calculated and the government payments and convenience fee payments are sent by the payment server for authorization. In this embodiment the transaction may also be voided after the transaction is authorized and a receipt has been printed. When a void is conducted the transaction information and the payment card information is entered again in the authorization device and the authorization of that transaction is then reversed on the payment card network and another receipt is issued indicating the transactions have been voided. This allows the government or educational entity to allow their citizen or student to opt out of the transaction at any time, even after the receipt is issued, in accordance with payment card company rules. It also precludes the government or educational entities authorized users from accessing the system on unauthorized computers. The void capability also allows governments and educational entities to review their transactions online and void any transactions at any time during the same day (before settlement), that they want to cancel. In this embodiment, when any of the transactions being sent during an authorization fails to authorize on the payment network (decline), all of the transactions are automatically declined. In this embodiment, duplicate transactions that are set at certain specific amount may be set to be automatically “forced” to be authorized. This eliminates duplicate flat rate convenience fees (e.g. Visa™ debit tax convenience fees) being authorized over a relatively short period of time, from being regularly declined on the system. This embodiment differs from existing point of sale and ecommerce technology that automatically calculate sales tax and shipping costs, in that, they process the purchase, the sales tax and the shipping costs as a single transaction and this inventive concept manages issues specific to simultaneous processing of multiple transactions including a differentiated convenience fee as a function of either the merchant category code or the payment type, including managing both voids (voluntary) and declines (involuntary) for the primary and secondary transactions and the convenience fee transaction including one or more of the transactions being declined while one or more of the transactions are also authorized in one authorization signal. This inventive concept further manages fixed or flat rate convenience fees that may be sent for authorization over a relatively short period of time and which may be flagged and declined as a duplicate transaction. These are all issues that have been created because of a differentiated convenience fee and for which there is no present solution.

In one embodiment, the present invention may provide an ecommerce or integrated voice response (IVR) integrated (payment gateway) solution that is accessed directly by the government's citizens or the educational entities students via a web page or the telephone. This embodiment may also allow for payments made via e-check and or ACH (automated clearing house) or EFT (Electronic Funds Transaction) including recurring transactions with or without a convenience fee. In this embodiment, the present invention may also be integrated with a bill presentment system, recurring billing system or kiosk. The present invention differs from existing on-line payment, bill presentment, recurring billing or interactive voice response systems that automatically calculate a sales tax, shipping costs and convenience fees, in a number of ways. First it allows for the convenience fee to be calculated not only by the transaction amount but also by one or more of a number of factors including, payment card characteristic or payment type that may vary in the future as a result of changes in credit card company operating rules. Secondly, it allows for a differentiated convenience fee to be applied to different payment items as a function of the merchant category code, the payment type (e.g. tax) and/or the payment card characteristics (e.g. Visa™ debit). This requires the gateway or integrated solution to manage multiple merchant accounts. Thirdly, it automatically authorizes two or more separate transactions and settles them to one or more merchant accounts as the differentiated convenience fee may be a function of a different merchant category code/merchant ID (e.g. tax payments) and other types of payments may also be being collected by that government or educational entity. Lastly it manages a decline of any of the separate transactions by declining all of the transactions. This eliminates a situation where the convenience fee is authorized and the government's fees are declined or vice versa.

The present invention differs from an ATM that charges a separate service fee, depending on the bank or credit card account for payment card and the associated debit card network used to facilitate the transaction, in a number of ways. The present invention allows for the convenience fee to be calculated as a function of the payment card characteristics and the payment type, not just transaction amount. The present invention also submits and processes the convenience fee as a separate transaction.

The present invention has the unexpected advantages of being able to automatically calculate and aggregate secondary fees (such as an issuing fee) that may be collected by a second level of government and settling those fees automatically to that governments deposit (merchant) account.

In one embodiment, the present invention provides a system comprising: one or more payment servers hereinafter payment server(s) for determining convenience fees for transactions paid using two or more types of payment cards (e.g. credit and debit cards). The one or more payment servers are in electronic communication with a payment card financial network for authorizing and settling transactions for two or more types of payment cards. Each transaction may comprise one or more government and/or one or more educational payments, government payments, including possibly a secondary (e.g. issuing) fee. The authorization device, which is in electronic communication with the payment server, allows the user to enter the payment and the payment card information. The one or more payment servers may determine the convenience fee for each payment as a variable (percentage), fixed or flat fee as a function of the transaction amount and/or also possibly as a function of the payment card characteristics, the payment type characteristics and/or the payment channel characteristics. The amount for the government payments and the convenience fee are optionally displayed to a user to allow the user to authorize or decline the payment for the government payments and the convenience fee wherein the payment server submits the government payments and the convenience fee for authorization simultaneously.

In one embodiment, the present invention provides a method comprising the following steps: (a) a user logging into the system with a user name and password (optional) (b) a user entering payment information and payment card information to pay for one or more government payments; (c) automatically determining any secondary fee (e.g. an issuing fee collected by one level of government that is collecting a fee for another level of government), if required, and a convenience fee for one or more of the government payments and (d) presenting the payment details to the user on a video display for the user to authorize or decline the payment (optional); and (e) simultaneous submittal of all of the one or more government payments and the convenience fee as separate transactions for authorization, on a payment card financial network and subsequent (f) settlement of the transactions to thereby cause funds for each of the one or more government payments to be distributed from a payer account to a respective government account for each of the one or more government payments and to thereby cause funds for the convenience fee to be transferred from the payer account to a convenience fee account. Steps (c), (d), (e) and (f) may be performed by one or more payment servers that are in electronic communication with a payment card financial network for authorizing and settling transactions submitted by two or more types of payment cards.

In some embodiments of the present invention, step (d) may be omitted. The convenience fee determined in step (c) above may one or more of the following types of a convenience fee: a variable (percentage based), fixed or flat rate convenience fee as a function of the amount of the transaction, a payment card characteristic convenience fee determined based on the payment card brand (e.g. MasterCard™, Visa™, American Express™ or Discover™) and/or the payment card type (e.g. credit, debit, consumer, business, commercial, rewards or affinity card), a payment type convenience fee based either on the merchant category code or industry sector (tax payments, education, utilities) and/or the payment type in that merchant category code (e.g. taxes, tuition, small or large ticket), or a payment channel convenience fee (e.g. face to face, internet, smart card).

In one embodiment the present invention provides a system comprising an authorization device and one or more payment servers for entering payment and payment card information and determining any secondary (issuing) fees and any convenience fee for transactions paid using the two or more types of payment cards (i.e., credit cards, debit cards, etc. The one or more payment servers are in electronic communication with a payment card financial network for authorizing and settling transactions entered by two or more types of payment cards. Each transaction may comprise one or more government and/or educational payments, possibly a secondary (issuing) fee if required. The payment servers automatically determine the convenience fee for each transaction based on the transaction amount and/or the payment card characteristics, the payment type and/or the payment channel. The government payments, any secondary fees and any convenience fee may be displayed to a user before the user authorizes payment for the transactions The authorization device, which is in electronic communication with the payment server, allows the user to authorize the payment of the government or educational fees, any secondary fees and any convenience fees simultaneously with a single swipe or key entry of the payment card information, thereby automatically complying with payment card convenience fee requirements such Visa™'s Tax Payment Program requirements and MasterCard's “Best Practice” section of their convenience fee program rules.

In one embodiment of the present invention, the government and/or educational payments, any secondary fees and any convenience fee may be presented to user on a video display with an option to authorize or cancel the transaction.

In one embodiment of the present invention, the convenience fee may be a variable (percentage), fixed or flat fee based on the total transaction amount automatically determined by the system. In one embodiment of the present invention, the convenience fee may be a payment card characteristic, dependent differentiated convenience fee. In one embodiment of the present invention, the convenience fee may be a payment type dependent differentiated convenience fee automatically determined by the system. In one embodiment of the present invention, the convenience fee may be a payment channel dependent differentiated convenience fee automatically determined by the system.

In one embodiment of the present invention, voids (voluntary cancellations) or declines (involuntary cancellations) of any of the government payments, secondary fees or convenience fees cause all of the transactions to be automatically voided or declined respectively.

In one embodiment of the present invention, the system may employ a flat rate convenience fee that may be run consecutively on the system and is forced for authorization eliminating duplicate transaction declines.

In one embodiment of the present invention, different convenience fees may be applied to different government or education merchant category codes (merchant id's) and/or different government or merchant payment types (e.g taxes, tuition) in the same transaction.

In one embodiment of the present invention the government payments, any secondary fees and any convenience fee may be settled (deposited) to one or more deposit (merchant) accounts depending upon either merchant category code and/or payment type.

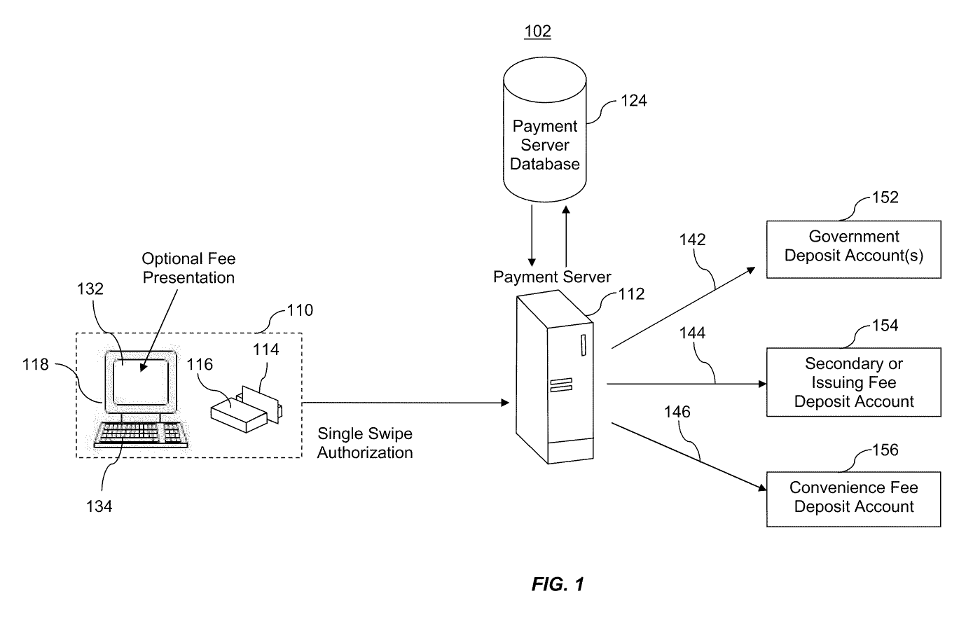

FIG. 1 shows the basic process of the system 102. A user (not shown) logs in (optional) to a data entry/authorization device 110 that communicates with a payment server 112. The log in process may also involve an authentication process such as the user entering a password or using a data entry device such as an id card on a card scanner or by performing a biometric scan. After log in, the user may enter the payment information including the amount of the payment, the type of payment, payee information and a reference or tracking number. The payment card information is then entered by swiping a payment card 114 through a magnetic card reader 116. Alternatively, the user may manually enter information for a payment card at step by typing the information into a data entry device 118. Completion of the entry of transaction and payment card information causes the information to be transmitted to the payment server 112 collectively as one more government payments. The payment server accesses the payment server database 124 calculates the convenience fee and any secondary or issuing fee and returns a signal to the visual display of the authorization device that shows the payment information for payments, including the government payments, any secondary or issuing fee, the calculated convenience fee and the total amount to be authorized. By selecting an authorization button on a visual display 132 or by entering a keystroke on a keyboard 134 of data entry device 118, a user simultaneously authorizes the payment of all of payments or cancels the transaction. The authorization is transmitted to payment server 112. Payment server 112, which is connected to a payment card network, indicated by arrows 142, 144 and 146, then authorizes: the government payments and subsequently settles the government payments to one or more government deposit account(s) 152, and simultaneously authorizes any secondary or issuing fee payment which is subsequently settled to any (secondary) issuing fee deposit account 154, and also simultaneously authorizes a convenience fee payment which is subsequently settled to a convenience fee deposit account 156 which may be held by the government or educational entity or a third party. Payment server 112 then updates the payment information for the user in payment server database 124.

Although FIG. 1 shows a system using a credit card and magnetic card reader as an authorization device, other embodiments of the present invention may use other types of payment cards and other types of authorization devices

Although the embodiment of the invention shown in FIG. 1 involves paying a secondary or issuing fee, other embodiments of the present invention may not require the paying of a secondary fee. In addition, the secondary fee may be another fee other than an issuing fee collected by another level of government or by a designated and authorized third party.

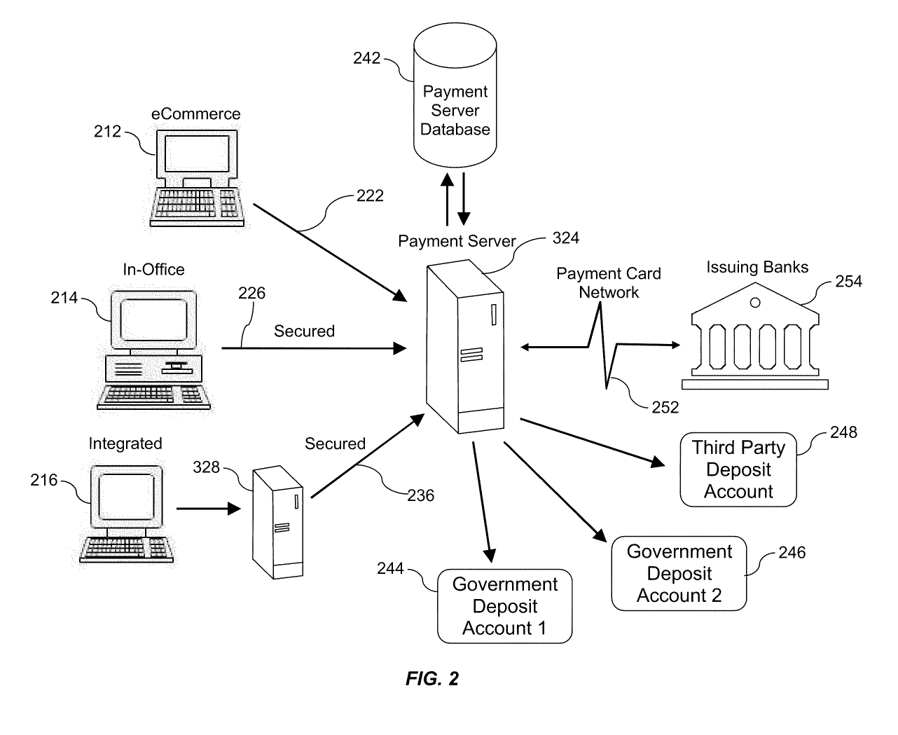

FIG. 2 is a diagram showing the three embodiments of the system of the present invention: an ecommerce system (which may or may not have a secure log in) 212, an in-office payment system 214 employing a virtual terminal with a secure login and an integrated system 216 that is integrated into existing business management software or IVR systems that may be operated in-office (software) or by a third party (IVR). Ecommerce system 212 has an unsecured connection (may have a secure log in connection—optional,) represented by arrow 222 to a payment server 224. In-office payment system 214 has a secured connection, represented by arrow 226, to payment server 224. Integrated API system 214 is connected to a secured server 228 that in turn has a secured connection, represented by arrow 236, to payment server 224. A payment server database 242, employed by payment server 224, keeps records of authentication information used in verifying the identity of a user during log-in, keeps records of payment information for the government fees, taxes and other government payments owed and/or paid various users, as well as information, including payment card characteristics, used to determine the issuing fee and convenience fee for the payment cards associated with the users. FIG. 2 shows government payments being settled to two different government accounts, government deposit account 1, indicated by reference character 244 and municipal deposit account 2, indicated by reference character 246 and the convenience fee being settled to a convenience fee deposit account 248. Payment server 224 is part of a payment card network 252 that includes one or more issuing banks 254 that issue payment cards to users.

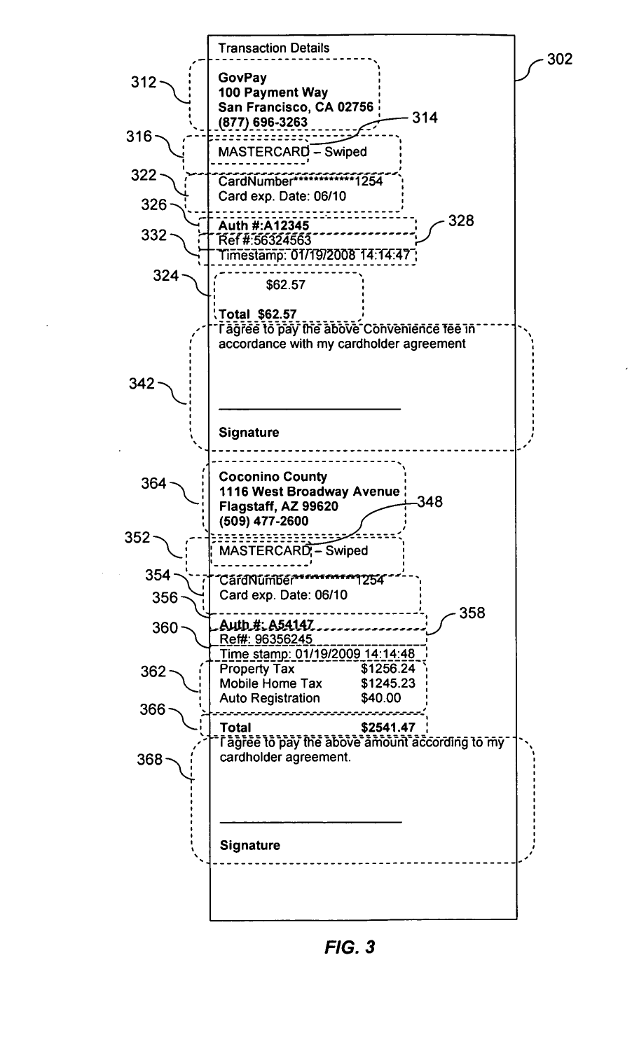

FIG. 3 shows a transaction receipt 302 according to one embodiment of the present invention. Transaction receipt 302 includes: a name of the party collecting the convenience fee 312, the name of the brand of the payment card that was used for payment 314, the method the card information was entered with (swiped/key entered) 316, a security protected card number and expiration date 322 for the payment card, a convenience fee 324 determined by a payment server, an authorization number 326, a reference number 328 and a time stamp 332 for when convenience fee 324 was determined, an authorization/signature line/space 342, a name of the government or educational entity collecting the payment, name of the brand of the card that was used 352 for the payment, the method the card information was entered with 352 a security protected card number and expiration date 3454 for the payment card, an authorization number 356 for the government payments transaction, a reference number 358 for the government payments transaction, a time stamp 360 for government payments transaction a detail list of the government payments 362 to be paid in the transaction, a government entity 364 to which government payments are to be paid, a total amount 366 for government payments 362, an authorization/signature line/space 368 for authorizing payment of government payments 362.

FIG. 4 shows the transaction process 402. A user starts the process by logging in at an entry device at step 408 (optional). At step 410 the user enters the government payments the user wishes to pay by. At step 414, the user enters payment card information for the transaction. The user may manually enter identification code information for a payment card at step 414 by typing the information into a data entry device for the system. Alternatively, at step 414, the user may enter the identification code information by swiping the payment card through a card reader or placing the card in proximity to a card reader. At step 416, the payment server calculates any secondary or issuing fees that may be collected by another level or government or authorized third party and based the amount of the transaction and possibly on one or more characteristics for the payment card, the payment type or the payment channel automatically determines the convenience fee for this transaction. At step 432, the total transaction information including the convenience fee and any secondary fees are (optionally) displayed to the user with an authorization/cancellation option. If step 432 is bypassed, the transaction is authorized automatically (step 436). If the user decides to not pay for the payments items, the transaction is cancelled at step 434. If the user decides to authorize the payment of the payment items, the payment items are simultaneously authorized at step 436. If one or more of the payments are declined at step 436, all of the payments are cancelled at step 438. Then a receipt is issued detailing all of payments authorized or declined at step 440. The payment server is updated at step 442. At step 444, the transaction may be voided. If a void is conducted at step 444, the transaction is selected from the payment server database information and the payment card information is again submitted to the payment server and the transaction is reversed and a receipt is issued detailing all of the payments as voided. At step 448 the payment server is again updated. At step 460 all of the day's transactions are automatically sent by the payment server to the payment card financial network to be settled (at a predetermined time). At step 462, each of the payments is settled into the appropriate deposit account. The government payments are settled to one or more government deposit account(s) 464. The secondary or issuing fee payment is settled to a secondary or issuing fee deposit account 466. The convenience fee payment is settled to a convenience fee deposit account 468. At step 480 the payment server is again updated with the settlement amounts.

Although the process of FIG. 4 shows the user entering payment card information the users payment card information may be on file and be automatically selected for the payment (recurring payment.) If the user has more than one payment card on file, the user may choose the payment card to use for this transaction after the entry device displays the possible payments cards for the user.

Although the process of FIG. 4 shows an issuing fee being determined and settled, in some embodiments of the present invention, it may not be necessary to determine and settle an issuing fee.

The order of the steps in the process shown in FIG. 4 may also be varied in some embodiments of the present invention. For example, the determination of the convenience fee may occur before the determination of the issuing fee. Also, the payment card information may be retrieved for the user by the processing system in response to the user logging in.

While the present invention has been disclosed with references to certain embodiments, numerous modification, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A system comprising:
an authorization device; and
one or more payment servers for entering payment and payment card information and determining any secondary fees and one or more differentiated convenience fees for transactions paid using the two or more types of payment cards,
wherein the one or more payment servers are in electronic communication with a payment card financial network for authorizing and settling transactions entered by two or more types of payment cards,
wherein each transaction comprises one or more government and/or one or more educational payments,
wherein the one or more payment servers automatically determine the one or more differentiated convenience fee for each transaction based on: the transaction amount and/or the payment card characteristics and/or the payment type and/or the payment channel,
wherein an authorization device in electronic communication with the payment server allows the user to authorize the payment of the one or more government payments and/or the one and/or more educational payments and the payment of the one or more convenience fees simultaneously with a single swipe or key entry of the payment card information, thereby automatically complying with one or more payment card differentiated convenience fee requirements.

2. The system of claim 1, wherein each transaction comprises an issuing fee and wherein the authorization device in electronic communication with the payment server allows the user to authorize the payment of the issuing fee, the one or more government payments and/or the one or more educational payments and the payment of the one or more convenience fees simultaneously with a single swipe or key entry of the payment card information.

3. The system of claim 2, wherein the issuing fee, the one or more convenience fees and the one or more government payments and/or the one or more educational payments are displayed to a user on a visual display device before the user authorizes payment for the transactions.

4. The system of claim 3, wherein when the issuing fee, the one or more convenience fees and the one or more government payments and/or the one or more educational payments are displayed to a user on the visual display device, the user is provided with an option to authorize or cancel the transaction.

5. The system of claim 1, wherein the one or more convenience fees and the one or more government payments and/or the one or more educational payments are displayed to a user before the user authorizes payment for the transactions.

6. The system of claim 5, wherein when the one or more convenience fees and the one or more government payments and/or the one or more educational payments are displayed to a user on the visual display device, the user is provided with an option to authorize or cancel the transaction.

7. The system of claim 1, wherein the one or more payment card differentiated convenience fee requirements comprise the Visa™'s Tax Payment Program requirements.

8. The system of claim 1, wherein the one or more payment card differentiated convenience fee requirements comprise the MasterCard's “Best Practice” section of their convenience fee program rules.

9. The system of claim 1, wherein the differentiated convenience fee is a variable fee, fixed fee or flat fee based on the total transaction amount automatically determined by the system.

10. The system of claim 1, wherein the differentiated convenience fee is a payment card characteristic, dependent differentiated convenience fee

11. The system of claim 1, wherein the differentiated convenience fee is a payment type dependent differentiated convenience fee automatically determined by the system.

12. The system of claim 1, wherein the differentiated convenience fee is a payment channel dependent differentiated convenience fee automatically determined by the system

13. The system of claim 1, wherein a void or decline for any of the convenience fees, government payments or educational payments cause all of the transactions to be automatically voided or declined respectively.

14. The system of claim 1, wherein a flat rate convenience fee is forced for authorization eliminating duplicate transaction declines.

15. The system of claim 1, wherein a different differentiated convenience fees applied to different government or education merchant category codes and/or different government or merchant payment types in the same transaction.

16. The system of claim 15, wherein one or more differentiated convenience fees and the one or more government and/or one or more educational payments are settled to one or more deposit accounts depending upon merchant category code and/or payment type.
